(19) United States
(12) Patent Application Publication
(10) Pub. No.: US 2009/0069077 A1
(43) Pub. Date: Mar. 12, 2009

(54) GAMING MACHINE AND CONTROLLING METHOD THEREOF

(75) Inventors: Hiroki SAITO, Tokyo (JP); Hirobumi Toyoda, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 12/183,442

(22) Filed: Jul. 31, 2008

(30) Foreign Application Priority Data
Aug. 22, 2007 (JP) P2007-216104

(51) Int. Cl. G06F 17/00

(52) U.S. Cl. 463/25

(57) ABSTRACT

A gaming machine measures a lap time every time a leading horse passes a check point and sets a lap time in each of gaming terminals. When the lap time set for each gaming terminal matches the measured lap time, an award is provided to the matching gaming terminal.

### CROSS REFERENCE TO RELATED APPLICATIONS

This application is based upon and claims the benefit of priority from the prior Japanese Patent Application No. 2007-216104, filed on Aug. 22, 2007, the entire contents of which are incorporated herein by reference.

### BACKGROUND OF THE INVENTION

1. Field of the Invention

The present invention relates to a gaming machine for executing a horse racing game, and a controlling method thereof

2. Description of the Related Art

As to gaming machines for executing racing games, such as a horse racing game, the following patent documents are known.

U.S. Pat. No. 6,210,275 describes betting by use of bet methods such as quinella, perfecta, trifecta and superfecta, and preparing plural kinds of progressive bonuses having different establishment conditions. U.S. Pat. Nos. 6,358,150 and 6,450,887 describe determining payouts by use of plural horse racing game machines connected to each other through a network and betting based on previous races.

Japanese Patent Application Publication No. 2001-087461 describes nurturing of characters participating in a game by a player himself/herself. Japanese Patent No. 3291287 describes integration of odds among a plurality of horse racing game machines connected to each other online. Japanese Patent No. 3366308 describes calculation of odds based on a target payout rate and a winning percentage as well as correction of the odds thus calculated.

U.S. Pat. No. 6,921,331 describes execution of a racing game such as a horse racing game through a network. Japanese Patent Application Publication Nos. 2002-085852 and 2002-035429 describe playing a nurturing-type horse racing game in a wide area through a network.

U.S. Pat. No. 7,025,353 describes a horse racing board game. U.S. Pat. No. 7,172,508 describes executing a sports game and making a bet on an outcome of the game.

However, in none of the above patent documents, an award according to a progress of a horse racing game is provided. Thus, the player is often interested only in an outcome of the horse racing game but not in the progress of the horse racing game. Consequently, the player may get bored eventually with the horse racing game as he/she keeps on playing the horse racing game.

### SUMMARY OF THE INVENTION

The present invention was made to solve the problems as described above. It is an object of the present invention to provide a gaming machine capable of allowing a player to have an interest in a progress of a horse racing game, and to provide a controlling method thereof.

A first aspect of the present invention is a gaming machine comprising: a gaming terminal configured to receive a bet on a horse racing game having simulated racehorses race against each other within a simulated course; and a controller configured to (a) set a check point within the simulated course, (b) set a lap time for the gaming terminal, (c) execute the horse racing game, (d) measure a lap time when a leading horse passes the check point during execution of the horse racing game, and (e) provide an award from the gaming terminal upon the lap time set for the gaming terminal matching the measured lap time.

According to the first aspect of the present invention, a lap time when a leading horse passes a check point is measured in execution of a horse racing game. When a lap time set in a gaming terminal matches the measured lap time, an award is provided from the gaming terminal. Therefore, an award according to a progress of the horse racing game is provided. Thus, the player can keep up his/her interest in the progress of the horse racing game.

The controller may be configured to accumulate some of an amount of the bet received at the gaming terminal, and provide the accumulated bet amount as an award from the gaming terminal upon the lap time set for the gaming terminal matching the measured lap time.

According to the above configuration, the lap time when the leading horse passes the check point is measured in execution of the horse racing game. When the lap time set for each gaming terminal matches the measured lap time, an award is provided from the gaming terminal. Therefore, an award according to the progress of the horse racing game is provided. Thus, the player can keep up his/her interest in the progress of the horse racing game. Furthermore, an accumulated bet amount is provided as an award. Thus, resources of awards can be surely secured.

A second aspect of the present invention is a gaming machine comprising: a gaming terminal configured to receive a bet on a horse racing game having simulated racehorses race against each other within a simulated course; and a controller configured to (a) set a plurality of check points within the simulated course, (b) set a plurality of lap times for the gaming terminal, (c) execute the horse racing game, (d) measure a lap time every time a leading horse passes any of the plurality of check points during execution of the horse racing game, (e) determine, for each of the lap times set for the gaming terminal, whether or not a matching condition that the lap time set for the gaming terminal matches the measured lap time is satisfied, and (f) provide from the gaming terminal an award corresponding to a number of the lap times satisfying the matching condition.

According to the second aspect of the present invention, the lap time is measured every time the leading horse passes any of the plurality of check points during execution of the horse racing game. Moreover, for each of the lap times set in the gaming terminal, a determination is made on whether or not a matching condition that the lap time set for each gaming terminal matches the measured lap time is satisfied. Thereafter, an award is provided from the gaming terminal, the award corresponding to the number of the lap times satisfying the matching condition. Therefore, an award according to a progress of the horse racing game is provided. Thus, the player can keep up his/her interest in the progress of the horse racing game. Furthermore, the award corresponding to the number of the lap times satisfying the matching condition is provided. Thus, the player can keep up his/her interest also in the number of the lap times satisfying the matching condition. Consequently, the player's interest in the horse racing game can be maintained.

The controller may be configured to accumulate some of an amount of the bet received at the gaming terminal, and provide an amount corresponding to the number of the lap times satisfying the matching condition among the accumulated bet amount as an award from the gaming terminal.

According to the above configuration, the lap time is measured every time the leading horse passes any of the plurality of check points during execution of the horse racing game. Moreover, for each of the lap times set in the gaming terminal, a determination is made on whether or not a matching condition that the lap time set for each gaming terminal matches the measured lap time is satisfied. Thereafter, an award is provided from the gaming terminal, the award corresponding to the number of the lap times satisfying the matching condition. Therefore, an award according to a progress of the horse racing game is provided. Thus, the player can keep up his/her interest in the progress of the horse racing game. Furthermore, an accumulated bet amount is provided as an award. Thus, resources of awards can be surely secured. Furthermore, an amount corresponding to the number of the lap times satisfying the matching condition is provided as an award. Thus, the player can keep up his/her interest also in the number of the lap times satisfying the matching condition. Consequently, the player's interest in the horse racing game can be maintained.

The controller may be configured to provide the more bet amount as the award, as the larger number of the lap times satisfies the matching condition.

According to the above configuration, the lap time is measured every time the leading horse passes any of the plurality of check points during execution of the horse racing game. Moreover, for each of the lap times set in the gaming terminal, a determination is made on whether or not a matching condition that the lap time set for each gaming terminal matches the measured lap time is satisfied. Thereafter, an award is provided from the gaming terminal, the award corresponding to the number of the lap times satisfying the matching condition. Therefore, an award according to a progress of the horse racing game is provided. Thus, the player can keep up his/her interest in the progress of the horse racing game.

Furthermore, according to the above configuration, the accumulated bet amount is provided as an award. Thus, resources of awards can be surely secured. Furthermore, a bet amount corresponding to the number of the lap times satisfying the matching condition is provided as an award. Thus, the player can keep up his/her interest also in the number of the lap times satisfying the matching condition. Consequently, the player's interest in the horse racing game can be maintained. Particularly, according to the above configuration, the larger the number of the lap times satisfying the matching condition becomes, the more bet amount is provided as the award. Thus, it is expected for the player to wish that as many lap times as possible satisfy the matching condition. Consequently, the player's interest in the horse racing game is expected to be maintained.

A third aspect of the present invention is a gaming machine comprising: a gaming terminal configured to receive a bet on a horse racing game having simulated racehorses race against each other within a simulated course; and a controller configured to (a) set a check point within the simulated course, (b) set a lap time for the gaming terminal, (c) execute the horse racing game, (d) measure a lap time when a leading horse passes the check point during execution of the horse racing game, (e) determine whether or not a predetermined condition set for the gaming terminal is satisfied, (f) upon satisfaction of the predetermined condition, determine whether or not a matching condition that the lap time set for the gaming terminal matches the measured lap time is satisfied, and (g) provide an award from the gaming terminal upon satisfaction of the matching condition.

According to the third aspect of the present invention, the lap time when the leading horse passes the check point is measured during execution of the horse racing game. If the lap time set for each gaming terminal matches the measured lap time, an award is provided from the gaming terminal. Therefore, an award according to the progress of the horse racing game is provided. Thus, the player can keep up his/her interest in the progress of the horse racing game.

Furthermore, according to the third aspect of the present invention, the gaming machine neither determines whether or not the matching condition is satisfied nor provides an award unless the predetermined condition is satisfied. Thus, the player can be allowed to have expectations for satisfaction of the predetermined condition. Consequently, the player's interest in the horse racing game can be maintained.

A fourth aspect of the present invention is a gaming machine comprising: a plurality of gaming terminals configured to receive bets on a horse racing game having simulated racehorses race against each other within a simulated course; and a controller configured to (a) set a check point within the simulated course, (b) set a lap time for each of the gaming terminals, (c) execute the horse racing game, (d) measure a lap time when a leading horse passes the check point during execution of the horse racing game, (e) determine whether or not a predetermined condition set for each of the gaming terminals is satisfied, (f) determine, for the gaming terminal satisfying the predetermined condition, whether or not a matching condition that the lap time set for the gaming terminal matches the measured lap time is satisfied, and (g) provide an award from the gaming terminal satisfying the matching condition.

According to the fourth aspect of the present invention, the lap time when the leading horse passes the check point is measured during execution of the horse racing game. If the lap time set for each gaming terminal matches the measured lap time, an award is provided from the gaming terminal. Therefore, an award according to the progress of the horse racing game is provided. Thus, the player can keep up his/her interest in the progress of the horse racing game.

Furthermore, according to the fourth aspect of the present invention, the gaming machine determines whether or not the predetermined condition is satisfied for each of the gaming terminals and determines whether or not the matching condition is satisfied for each gaming terminal satisfying the predetermined condition. Therefore, the player playing a game at the gaming terminal that does not satisfy the predetermined condition feels “I want to have fun, too” by watching the player playing the game at the gaming terminal satisfying the predetermined condition enjoy the progress of the horse racing game. Consequently, the player's interest in the horse racing game is expected to be maintained.

A fifth aspect of the present invention is a method for controlling a gaming machine, comprising: receiving, at a gaming terminal, a bet on a horse racing game having simulated racehorses race against each other within a simulated course; setting a check point within the simulated course; setting a lap time for the gaming terminal; executing the horse racing game; measuring a lap time when a leading horse passes the check point during execution of the horse racing game; and providing an award from the gaming terminal upon the lap time set for the gaming terminal matching the measured lap time.

According to the fifth aspect of the present invention, the lap time when the leading horse passes the check point is measured during execution of the horse racing game. If the lap time set for each gaming terminal matches the measured lap time, an award is provided from the gaming terminal. Therefore, an award according to the progress of the horse racing game is provided. Thus, the player can keep up his/her interest in the progress of the horse racing game.

### BRIEF DESCRIPTION OF THE DRAWINGS

FIG. 1 is a flowchart schematically showing procedures of processing executed by a gaming machine according to an embodiment of the present invention.

FIG. 2 is a perspective view showing an entire configuration of the gaming machine according to the embodiment of the present invention.

FIG. 3 is a perspective view showing a configuration of a gaming terminal provided in the gaming machine according to the embodiment of the present invention.

FIG. 4 is a network connection diagram of the gaming machine according to the embodiment of the present invention.

FIG. 5 is a block diagram showing a control circuit of a horse racing game controller provided in the gaming machine according to the embodiment of the present invention.

FIG. 6 is a block diagram showing a control circuit of a gaming terminal provided in the gaming machine according to the embodiment of the present invention.

FIG. 7 is a flowchart showing processing operations of the gaming machine according to the embodiment of the present invention.

FIG. 8 is a flowchart showing processing operations of the gaming machine according to the embodiment of the present invention.

FIG. 9 is a flowchart showing processing operations of the gaming machine according to the embodiment of the present invention.

FIG. 10 is an explanatory view showing an example of a bet screen displayed in the gaming machine according to the embodiment of the present invention.

FIG. 11 is an explanatory view showing a roulette game executed as a side game in the gaming machine according to the embodiment of the present invention.

FIG. 12 is an explanatory view showing a bet screen for the roulette game executed as the side game in the gaming machine according to the embodiment of the present invention.

FIG. 13 is an explanatory view showing an image displayed in the gaming machine according to the embodiment of the present invention.

FIG. 14 is an explanatory view showing an image displayed in the gaming machine according to the embodiment of the present invention.

FIG. 15 is an explanatory view showing an image displayed in the gaming machine according to the embodiment of the present invention.

FIG. 16 is an explanatory view showing an image displayed in the gaming machine according to the embodiment of the present invention.

FIG. 17 is an explanatory view showing an image displayed in the gaming machine according to the embodiment of the present invention.

FIG. 18 is an explanatory view showing an image displayed in the gaming machine according to the embodiment of the present invention.

FIG. 19 is an explanatory view showing an image displayed in a gaming machine according to the embodiments of the present invention.

FIG. 20 is a perspective view showing another configuration of the gaming terminal provided in the gaming machine according to the embodiment of the present invention.

### DETAILED DESCRIPTION OF THE EMBODIMENTS

With reference to the drawings, embodiments of the present invention will be described below. In a gaming machine 10 according to the embodiment of the present invention, a horse race is executed by use of a large-sized display 11 and a horse race model 12 and a player predicts a finish order of racehorses at each gaming terminal. When the racehorses cross the finish line in the finish order as predicted, a payout (award) is provided.

The gaming machine 10 sets a lap time in each of gaming terminals 13 and measures a lap time every time a leading horse passes a predetermined check point during a horse racing game. When the lap time set for each gaming terminal 13 matches the measured lap time, the gaming machine 10 provides an award from the gaming terminal 13.

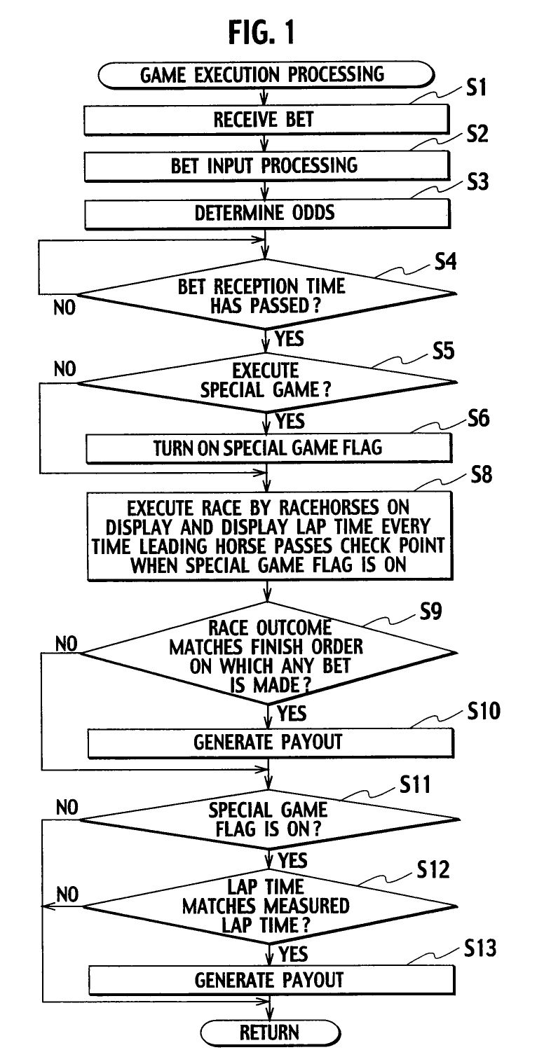

As shown in FIG. 1, in Step S1, a horse racing game controller 15 (controller) in a host server 14 receives a bet. In Step S2, bet input processing is executed by the player at each gaming terminal and the bet data is transmitted to the horse racing game controller 15.

In Step S3, the horse racing game controller 15 finds winning percentages of racehorses participating in a race and past race outcomes thereof by retrieving those from a data memory (memory) 16. Here, the “racehorses” mean simulated racehorses such as racehorses displayed as images on the large-sized display 11 or racehorse models provided on the horse race model 12.

In Step S4, the horse racing game controller 15 determines whether or not preset bet reception time (for example, 30 seconds) has passed. Once the bet reception time has passed, the processing advances to Step S5.

In Step S5, the horse racing game controller 15 determines whether or not to execute a special game. The processing advances to Step S6 when the special game is to be executed, and the processing advances to Step S8 when no special game is executed. In the special game, when the lap time when the leading horse passes the check point matches any of the lap times set in the gaming terminals 13, a payout (award) is provided at the gaming terminal 13 having the matching lap time. The check points are set at the early stage of the race, at the middle stage thereof, and the final stage thereof.

In Step S6, the horse racing game controller 15 turns on a special game flag. The special game flag indicates whether or not to execute the special game.

In Step S8, the horse racing game controller 15 executes a race by the racehorses. Specifically, the horse racing game controller 15 displays an image of the race on the large-sized display 11 and executes the same race on the horse race model 12. Here, when the special game flag is turned on, the horse racing game controller 15 measures a lap time every time a leading horse passes a check point and displays the lap time on the large-sized display 11.

In Step S9, each of the gaming terminals 13 determines whether or not an outcome of the race matches a finish order on which a bet is made. If the outcome matches the finish order on which the bet is made, for example, if a bet is made on No. “5” for “bet to win” and the racehorse No. “5” crosses the finish line first, the processing advances to Step S10. On the other hand, if the outcome of the race does not correspond to the finish order on which the bet is made, the processing advances to Step S11.

In Step S10, each of the gaming terminals 13 provides coins corresponding to the generated payout.

In Step S11, the horse racing game controller 15 determines whether or not the special game flag is on. If this condition is satisfied, the processing advances to Step S12, and if not, the processing is terminated.

In Step S12, the horse racing game controller 15 determines whether or not any one of the lap times set in the gaming terminals 13 matches the measured lap time. If this matching condition is satisfied, the processing advances to Step S13, and if not, the processing is terminated.

In Step S13, the gaming terminal 13 which satisfies the matching condition provides the number of coins corresponding to the number of lap times which satisfy the matching condition. Thereafter, the gaming machine 10 turns off the special game flag and terminates the processing.

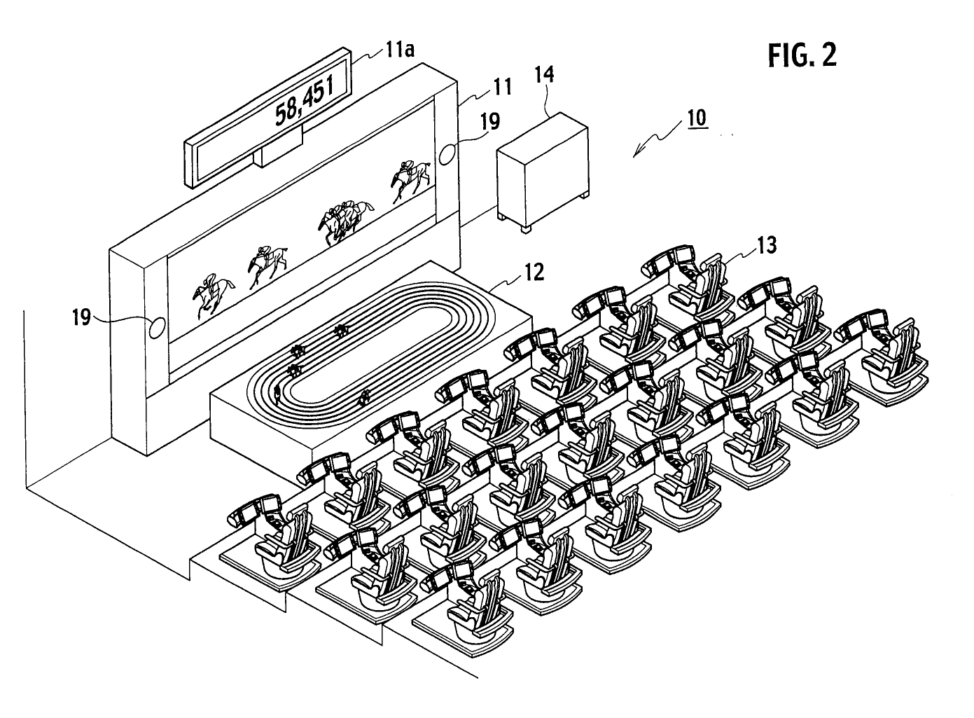

The embodiment of the present invention will be described in detail below. FIG. 2 is an external view of a gaming machine 10 according to an embodiment of the present invention. As shown in FIG. 2, the gaming machine 10 according to this embodiment includes: a large-sized display 11 for displaying images; an accumulated number display 11a provided above the large-sized display 11; speakers 19 which are provided at both ends of the large-sized display 11, respectively, and output sound effects; a horse race model 12 which is provided in front of the large-sized display 11 and executes a race by use of racehorse models; and a host server 14 which controls image display on the large-sized display 11, operations of the horse race model 12, and the like. Furthermore, a plurality of gaming terminals 13 are provided at positions facing a front of the large-sized display 11.

The large-sized display 11 displays images related to a race by a plurality of racehorses in execution of the race and displays odds for each of bet methods (bet to win, quinella, trifecta and the like) and the like before execution of the race. Here, the racehorse image displayed on the large-sized display 11 is an example of a simulated racehorse. On the accumulated number display 11a, the number of coins accumulated for a special game is displayed. The gaming machine 10 accumulates some of the coins bet by the player as coins for the special game, and provides the accumulated coins as a payout in the special game.

The horse race model 12 executes the same race as that displayed on the large-sized display 11 by operating the racehorse models on a model course. Specifically, when the race is executed, a situation of the race and an outcome thereof are displayed not only with images but also with three-dimensional models. Here, the racehorse model is an example of the simulated racehorse.

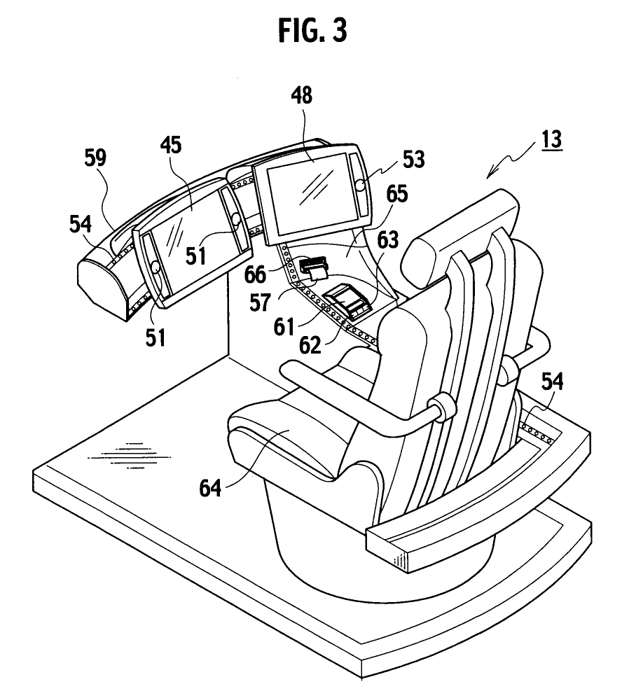

The gaming terminal 13 is a terminal where the player is seated to participate in repeatedly executed horse racing games. FIG. 3 is a perspective view showing a detailed configuration of the gaming terminal 13. As shown in FIG. 3, the gaming terminal 13 has a seat 64 for the player to be seated, a control box 65 provided to the right of the seat 64 and an arm 59 provided in a horizontal direction in front of the seat 64.

The arm 59 is provided with: a main game display (small-sized display) 45 for displaying various images related to the horse racing game; and a sub game display 48 for displaying images related to a side game other than the horse racing game. To the right and left of the main game display 45, speakers 51 is provided for outputting sound effects related to the images to be displayed on the main game display 45. To the right of the sub game display 48, a speaker 53 is provided for outputting sound effects related to the images to be displayed on the sub game display 48.

The control box 65 is provided with: a coin storage box 61 for the player to insert coins into; an opening button 62 for opening a lid of the coin storage box 61; and a closing button 63 for closing the lid of the coin storage box 61. Thus, the player can insert coins into the coin storage box 61.

In front of the coin storage box 61, provided are: a bill insertion slot 66 for the player to insert bills into; and a ticket printer 57 for printing out data on a payout.

In a side portion of the control box 65 and the arm 59, lamps 54 formed of a number of LEDs and the like are provided. When a payout is generated for a prediction made about a finish order of a race at the gaming terminal 13, the lamps 54 are lighted, flashed or operated otherwise to draw attentions of players playing at the gaming terminals 13 therearound.

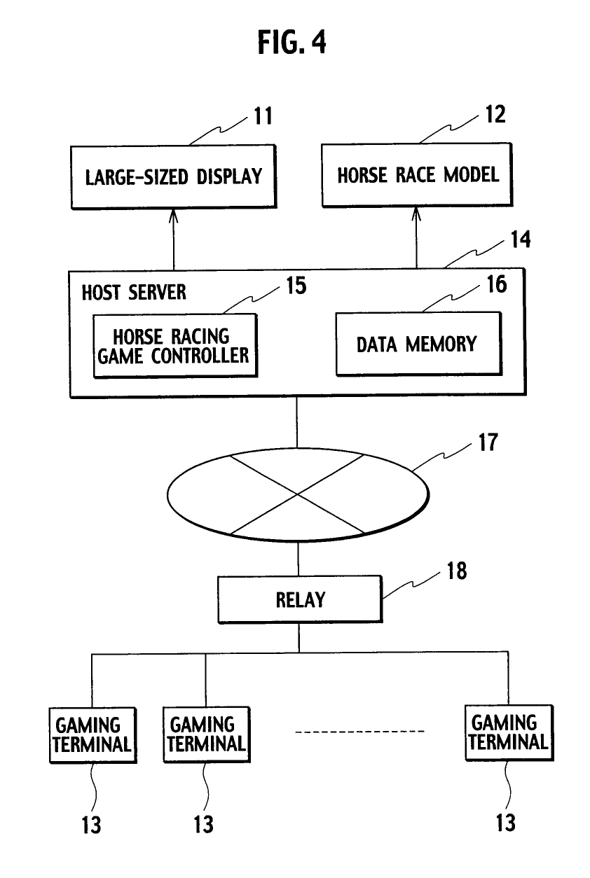

FIG. 4 is a network connection diagram of the gaming machine 10 according to the embodiment. As shown in FIG. 4, the host server 14 is connected to each of the gaming terminals 13 through a network 17 and a relay 18.

The host server 14 includes: a horse racing game controller 15 which performs control of executing a horse racing game; and a data memory (memory) 16 which stores various data required to execute the horse racing game, such as past race outcomes of the racehorses and winning percentages of the racehorses.

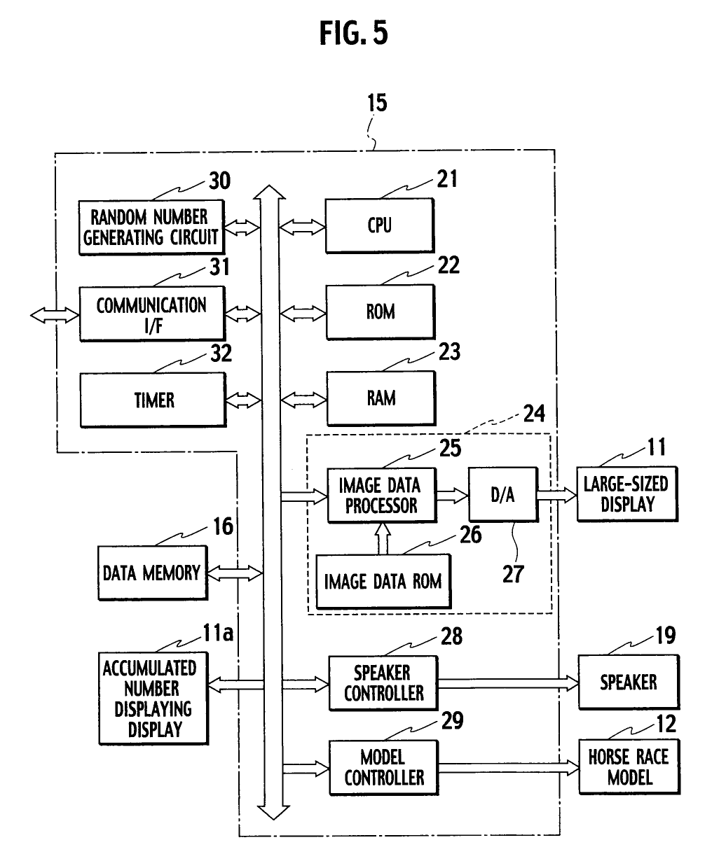

Next, a configuration of the horse racing game controller 15 will be described. FIG. 5 is a block diagram showing a detailed configuration of the horse racing game controller 15. As shown in FIG. 5, the horse racing game controller 15 includes: a CPU 21 which controls the entire horse racing game controller 15; a ROM 22 which stores a horse racing game program and a system program for executing the horse racing game program; a RAM 23 which writes and retrieves various data required to execute the horse racing game program; and a display control circuit 24 which generates and outputs image data to be displayed on the large-sized display 11.

The display control circuit 24 includes: an image data ROM 26 which stores various image data such as background image data and racehorse image data; an image data processor 25 which creates new image data based on the various image data stored in the image data ROM 26; and a D/A converter 27.

The horse racing game controller 15 further includes: a speaker controller 28 which generates sound data to be outputted by the speakers 19 provided on the large-sized display 11; and a model controller 29 which executes a race by the racehorse models run on the horse race model 12.

The horse racing game controller 15 further includes: a random number generating circuit 30 which generates random numbers for determining a finish order of the racehorses to participate in each race in execution of the race or for determining the racehorses to participate in each race; a timer 32 used for counting bet reception time, and the like; and a communication interface 31 for communicating with each of the gaming terminals 13 through the network 17.

The horse racing game controller 15 is connected to the data memory 16 and can retrieve the data stored in the data memory 16, such as the past race outcomes of the racehorses and the winning percentages of the racehorses, from the data memory 16. Moreover, the horse racing game controller 15 can also write data such as new race outcomes into the data memory 16. The horse racing game controller 15 is connected to the accumulated number display 11a.

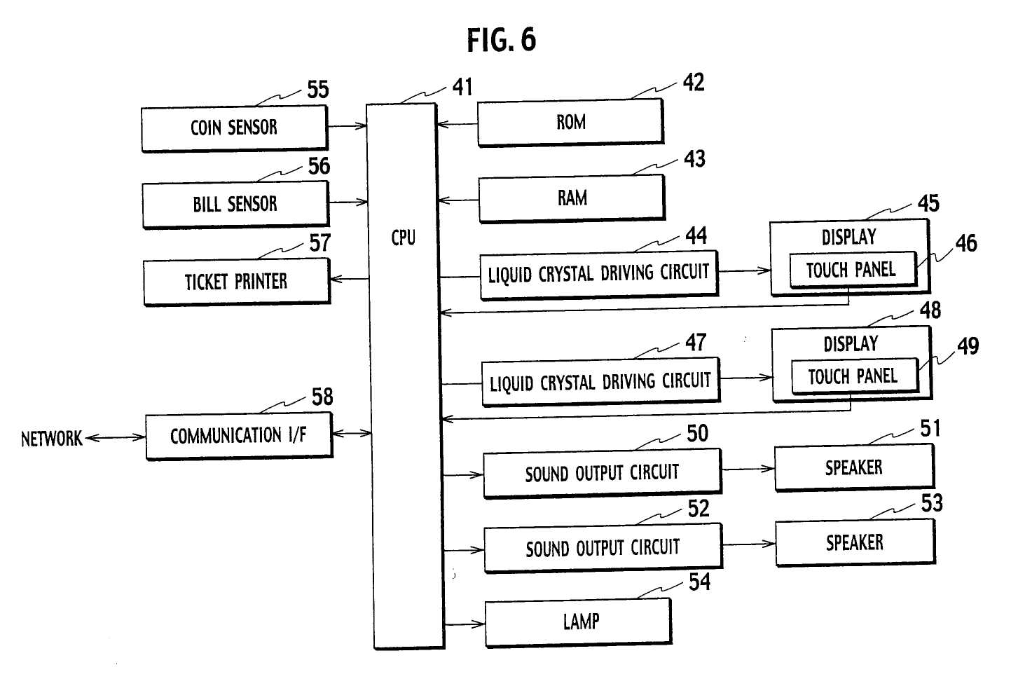

Next, with reference to a block diagram shown in FIG. 6, a configuration of each of the gaming terminals 13 will be described. The gaming terminal 13 includes: a CPU 41 which controls the entire gaming terminal 13; a ROM 42 which stores a system program for operating the gaming terminal 13; and a RAM 43 which writes and retrieves various data.

The gaming terminal 13 further includes: a liquid crystal driving circuit 44 which generates image data to be displayed on the main game display 45 and outputs the image data thus generated to the main game display 45; and a liquid crystal driving circuit 47 which generates image data to be displayed on the sub game display 48 and outputs the image data thus generated to the sub game display 48.

As described above, the main game display (small-sized display) 45 is a display for displaying the images related to the horse racing game, and includes a touch panel 46 on a surface of a display screen. Accordingly, the player can input various information, such as a racehorse to bet on, the number of bets, a paddock image display request, a training (breaking) image display request and a previous race display request, by touching the touch panel 46.

The sub game display 48 is a display for displaying images related to a sub game other than the horse racing game, and includes a touch panel 49 on a surface of a display screen. Accordingly, the player can input various information related to execution of the sub game by touching the touch panel 49.

The gaming terminal 13 further includes: a sound output circuit 50 which generates sound effects related to the images to be displayed on the main game display 45; a sound output circuit 52 which generates sound effects related to the images to be displayed on the sub game display 48; and the lamps 54. The sound effects generated by the sound output circuit 50 are outputted from the speakers 51, and the sound effects generated by the sound output circuit 52 are outputted from the speaker 53.

The gaming terminal 13 further includes: a coin sensor 55 for detecting the coins inserted into the coin storage box 61 shown in FIG. 3; a bill sensor 56 for detecting the bills inserted into the bill insertion slot 66; the ticket printer 57 for printing out data indicating the current number of credits; and a communication interface 58 for performing data communication with the host server 14 through the network 17.

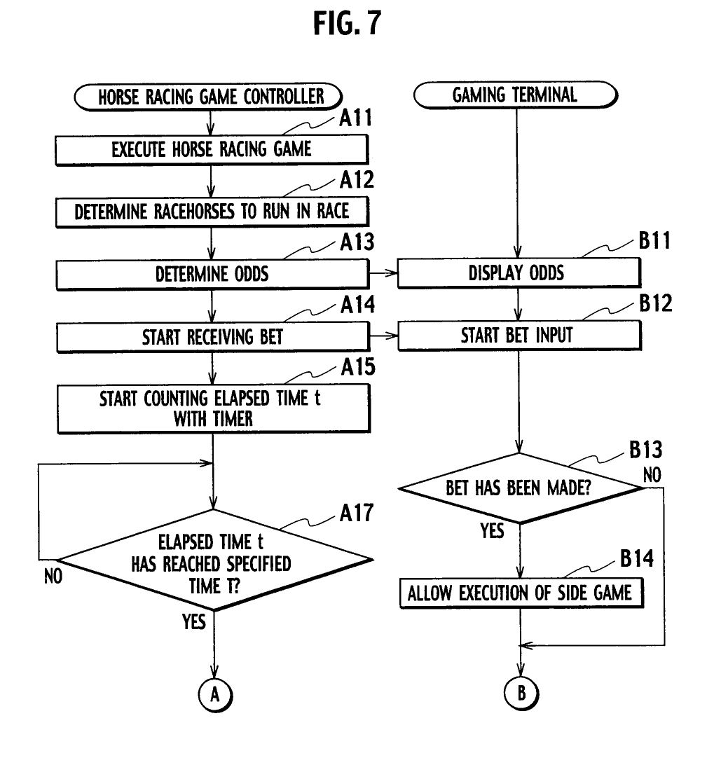

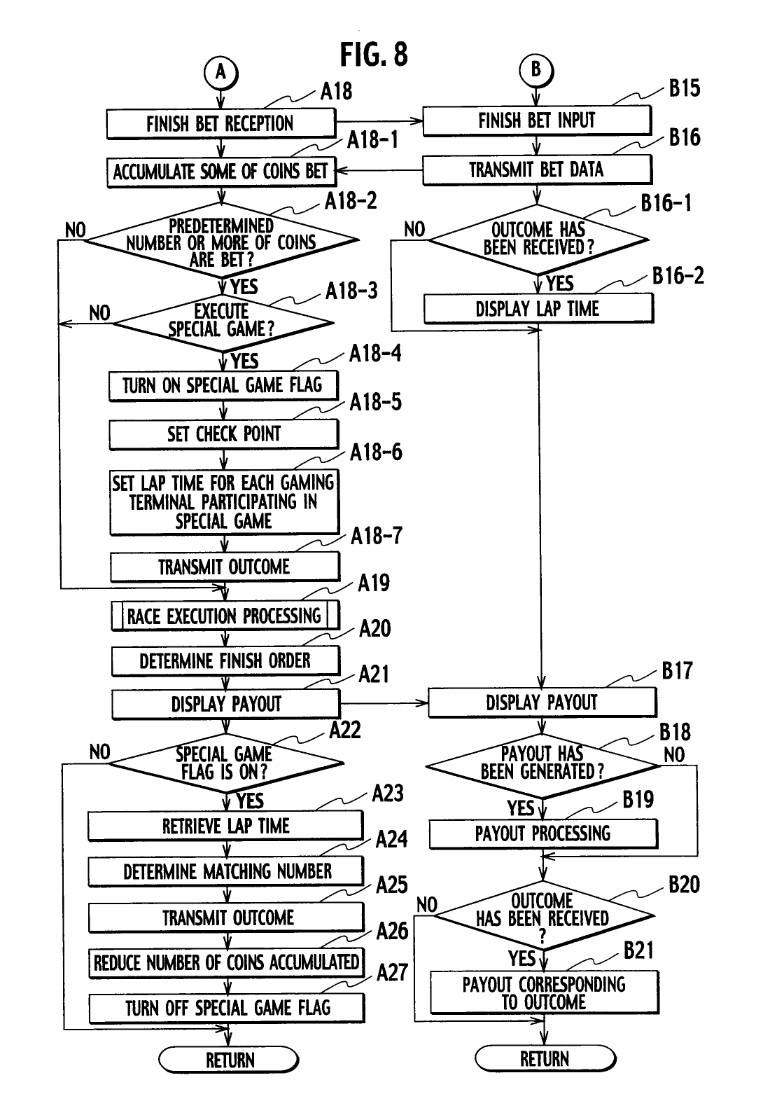

Next, with reference to flowcharts shown in FIGS. 7 and 8, description will be given of operations of the gaming machine 10 according to the embodiment of the present invention.

First, in Step A11 in FIG. 7, the horse racing game controller 15 starts execution of a horse racing game.

In Step A12, the horse racing game controller 15 determines racehorses to run in a current race. In this step, the horse racing game controller 15 randomly selects a predetermined number (for example, 8) of racehorses from a plurality of racehorses stored in the data memory 16 based on the random number generated by the random number generating circuit 30, and sets the selected racehorses as the racehorses to run in the current race. In this event, entry numbers “1” to “8” are assigned to the racehorses to run in the race. Moreover, as a method for determining the racehorses to run, the plurality of racehorses may be set to run in turn.

In Step A13, the horse racing game controller 15 executes processing of determining odds for each of bet methods such as bet to win, quinella and trifecta. In this event, the horse racing game controller 15 sets the odds based on winning percentage data on racehorses each, the data being stored in the data memory 16. Therefore, odds for a finish order prediction including the racehorse having a high winning percentage are set to a low multiplication factor, and odds for a finish order prediction including the racehorse having a low winning percentage are set to a high multiplication factor. The odds thus determined by the above processing are displayed on the large-sized display 11, outputted through the communication interface 31 and transmitted to each of the gaming terminals 13 through the network 17 and the relay 18.

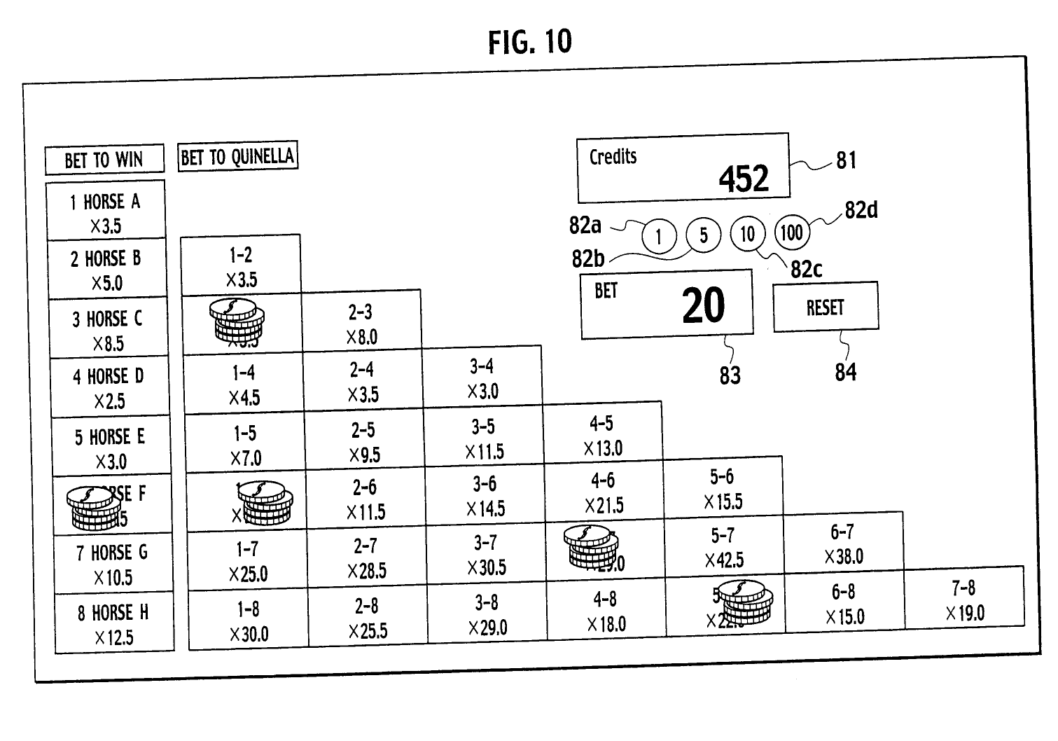

In Step B11, the gaming terminal 13 receives the odds data transmitted from the horse racing game controller 15 and displays the odds on the main game display 45. As a result, a bet screen for “bet to win” and “bet to quinella” are displayed on the main game display 45, for example, as shown in FIG. 10. In FIG. 10, for example, odds for “bet to win” of “horse A” that is a horse running in a race are determined to be “×3.5” and odds for “bet to quinella” of “horse B” and “horse C” are determined to be “×8.0”. The player can be informed of the odds by looking at the screen.

In Step A14, the horse racing game controller 15 starts receiving bets for each of the bet methods in the current race.

In Step B12, the player starts bet input. Specifically, the player can make a bet on a predicted finish order combination by operating the touch panel 46 while looking at the odds displayed on the bet screen displayed on the main game display 45. As shown in FIG. 10, on the main game display 45, a credit number display screen 81, coin selection screens 82a to 82d, a bet number display screen 83 and a reset screen 84 are displayed, besides the bet screen described above.

On the credit number display screen 81, the number of credits (the number of coins) accumulated in the gaming terminal 13 is displayed. Moreover, a bet number is added by touching any of the coin selection screens 82a to 82d and displayed on the bet number display screen 83. For example, a bet number “5” is added by touching the coin selection screen 82b, and a bet number “10” is added by touching the coin selection screen 82c. Therefore, a desired bet number can be selected by touching any of the coin selection screens 82a to 82d. When a desired finish order combination on the bet screen is touched after the bet number is determined, a bet is made on this finish order combination. For example, if a position of “1-3” on the bet screen is touched when the bet number is set to “20”, 20 coins are bet on this finish order combination. Moreover, the reset screen 84 is used for canceling the credits once bet.

Next, in Step A15 in FIG. 7, the horse racing game controller 15 starts counting elapsed time t with the timer 32.

In Step A17, the horse racing game controller 15 determines whether or not the elapsed time t counted by the timer 32 has reached preset specified time T (for example, 30 seconds). When the elapsed time t has reached the specified time T, the processing moves to Step A18 shown in FIG. 8.

In Step B13, the gaming terminal 13 determines whether or not a bet operation has been made by the player. When it is determined that the bet operation has been made by the player, the processing moves to Step B14.

In Step B14, the gaming terminal 13 allows execution of a side game. The side game is a game different from the horse racing game and executed on the sub-game display 48 shown in FIG. 3.

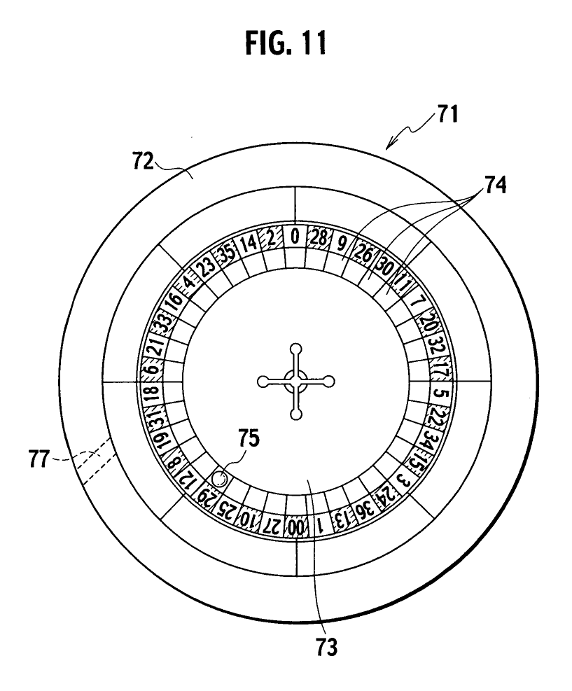

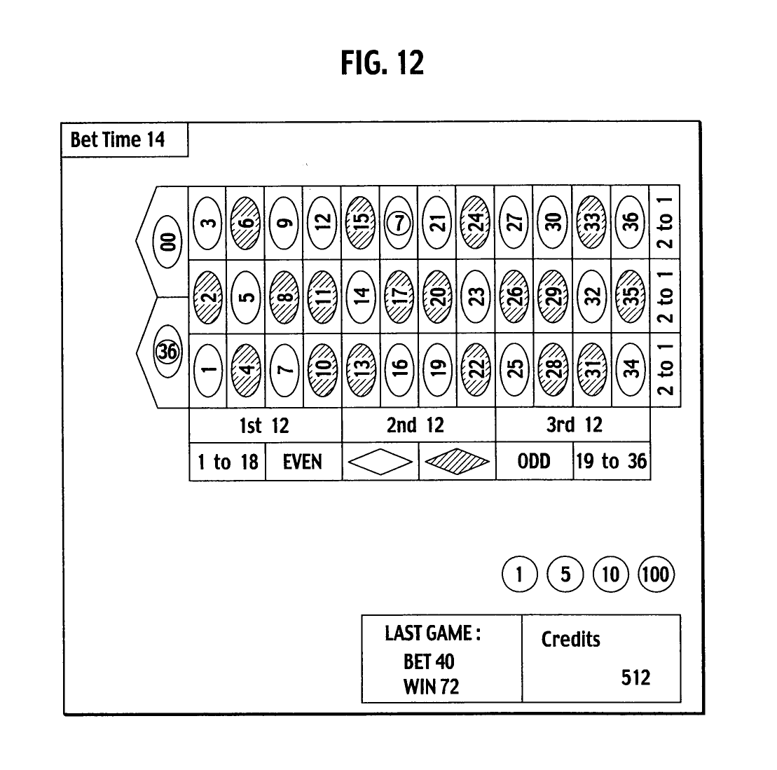

FIG. 11 is an explanatory view showing a roulette game that is an example of the side game. FIG. 12 is an explanatory view showing a bet screen for the roulette game. As shown in FIG. 11, a roulette game 71 is a game played as follows. Specifically, a roulette wheel 73 is rotated relative to a frame body 72 and a ball 75 is inserted from a ball insertion opening 77. Thereafter, a payout is determined according to a number of a number pocket 74 in which the ball 75 is housed.

On the sub-game display 48 in the gaming terminal 13, a bet screen is displayed as shown in FIG. 12. A bet is made on an arbitrary number on the bet screen by touching the touch panel 49. Thereafter, an image of the roulette game shown in FIG. 11 is displayed and the roulette game is executed. Subsequently, if the number of the number pocket 74 having the ball 75 housed therein corresponds to the number on which the bet has been made on the bet screen by the player, a payout is generated and coins are provided as a payout. As described above, when a bet is made on the horse racing game at the gaming terminal 13, the side game, for example, the roulette game can be executed. Therefore, since the player who has finished the bet operation can play the side game while waiting for bet reception termination time, he/she never gets bored.

Next, in Step A18 in FIG. 8, the horse racing game controller 15 terminates the bet reception. Specifically, when the specified time T has passed since the start of the bet reception, the bet reception is terminated and a signal indicating the bet reception termination is transmitted to each of the gaming terminals 13.

In Step B15, the gaming terminal 13 terminates the bet input upon receipt of the signal indicating the bet reception termination. Thereafter, in Step B16, the gaming terminal 13 transmits, to the horse racing game controller 15, bet data indicating contents of the bets made at the gaming terminal 13.

In Step A18-1, the horse racing game controller 15 stores the bet data received from each of the gaming terminals 13 and accumulates some of the coins bet at each of the gaming terminals 13. To be more specific, the horse racing game controller 15 sums up the numbers of the coins bet at the respective gaming terminals 13 based on the bet data received from each of the gaming terminals 13. The horse racing game controller 15 adds a value equivalent to a predetermined % (for example, 5%) of the value thus obtained to an accumulation coin counter (initial value is 0). Moreover, the horse racing game controller 15 displays the value in the accumulation coin counter on the accumulated number display 11a.

In Step A18-2, for each gaming terminal 13, the horse racing game controller 15 determines, based on the bet data, whether or not a predetermined number or more of coins are bet on a horse racing game. If there exists any gaming terminal 13 which satisfies the above condition, the processing advances to Step A18-3. On the other hand, if the above condition is not satisfied, the processing advances to Step A19. The predetermined number may be fixed or randomly changed for each horse racing game or for each of the gaming terminals 13.

In Step A18-3, the horse racing game controller 15 determines whether or not to execute a special game. To be more specific, the horse racing game controller 15 acquires one random number from the random number generating circuit 30. Thereafter, the horse racing game controller 15 determines that the special game is to be executed if the random number is a value within a predetermined range, and determines that the special game is not to be executed if the random number is a value outside the predetermined range. If the special game is to be executed, the horse racing game controller 15 moves to Step A18-4, and if not, moves to Step A19.

In Step A18-4, the horse racing game controller 15 turns on a special game flag.

In Step A18-5, the horse racing game controller 15 sets check points at positions in a course corresponding to early, middle and latter stages of the race, respectively.

In Step A18-6, the horse racing game controller 15 allows the gaming terminal 13 satisfying the condition in Step A18-2 to participate in the special game. Moreover, the horse racing game controller 15 sets and stores three lap times for each of the gaming terminals 13 participating in the special game.

In Step A18-7, the horse racing game controller 15 transmits, to each of the gaming terminals 13 participating in the special game, lap time data indicating the three lap times set for the gaming terminal 13.

In Step B16-1, the gaming terminal 13 determines whether or not the lap time data has been received from the horse racing game controller 15. If this condition is satisfied, the processing advances to Step B16-2, and if not, the processing advances to Step B17.

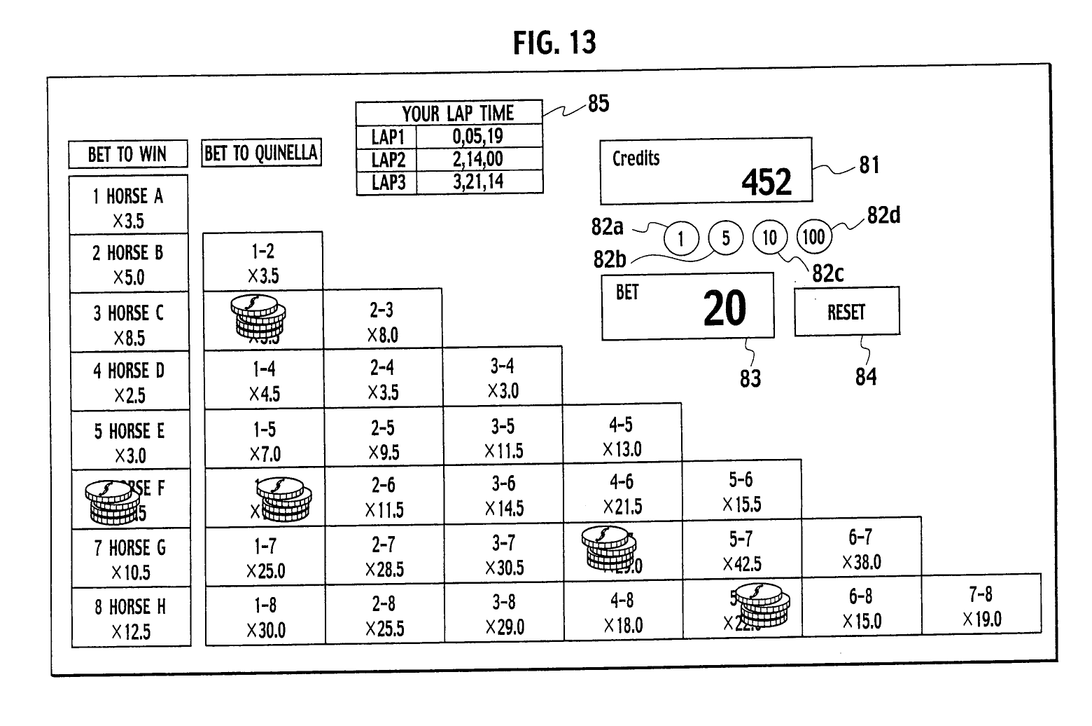

In Step B16-2, based on the lap time data received from the horse racing game controller 15, the gaming terminal 13 displays the three lap times set for the gaming terminal 13 on the main game display 45. FIG. 13 shows a display example.

In Step A19, the horse racing game controller 15 executes a race by the racehorses. This processing will be described in detail later.

In Step A20, the horse racing game controller 15 determines a finish order of the racehorses as an outcome of the execution of the race, and updates the data in the data memory 16 based on the finish order.

In Step A21, the horse racing game controller 15 calculates a payout based on the determined finish order and displays the calculated payout on the large-sized display 11. For example, payout data, such as “bet to win” No. “5”, payout “×3.0”, quinella “2-5” and payout “×9.5”, is displayed on the large-sized display 11. Furthermore, this payout data is transmitted to each of the gaming terminals 13.

In Step B17, the gaming terminal 13 displays the payout on the main game display 45. Thus, the player participating in the horse racing game at each of the gaming terminals 13 can be informed of the payout for the current race.

In Step B18, the gaming terminal 13 determines whether or not any payout is generated at the gaming terminal 13. If any payout is generated, the gaming terminal 13 provides coins corresponding to the payout in Step B19.

In Step A22, the horse racing game controller 15 determines whether or not the special game flag is on. If this condition is satisfied, the processing advances to Step A23, and if not, the processing is terminated.

In Step A23, the horse racing game controller 15 compares the lap times set for each of the gaming terminals 13 with three measured lap times for each of the gaming terminals 13 that have participated in the special game. Note that, in race execution processing to be described later, the horse racing game controller 15 measures and stores a lap time every time a leading horse passes a check point.

In Step A24, for each of the gaming terminals 13 that have participated in the special game, the horse racing game controller 15 determines whether or not any of the lap times set for the gaming terminal 13 matches the measured lap time. Moreover, for each of the gaming terminals 13 satisfying the matching condition, the horse racing game controller 15 determines the number of the lap times satisfying the matching condition, in other words, determines how many lap times set for the gaming terminal 13 match the measured lap time. Thereafter, based on a result of the determination and the value in the accumulation coin counter, the number of coins to be provided as a payout in the special game is determined. To be more specific, if all the lap times set for the gaming terminal 13 match the measured lap times, the horse racing game controller 15 sets a value equivalent to 50% of the value in the accumulation coin counter as a payout number for the gaming terminal 13. Moreover, if two of the lap times set for the gaming terminal 13 match the measured lap times, the horse racing game controller 15 sets a value equivalent to 10% of the value in the accumulation coin counter as the payout number for the gaming terminal 13. Furthermore, if one of the lap times set for the gaming terminal 13 matches the measured lap time, the horse racing game controller 15 sets a value equivalent to 5% of the value in the accumulation coin counter as the payout number for the gaming terminal 13.

In Step A25, the horse racing game controller 15 transmits, to each of the gaming terminals 13 satisfying the matching condition, special game payout data indicating the payout number for the gaming terminal 13.

In Step B20, the gaming terminal 13 determines whether or not the special game payout data has been received from the horse racing game controller 15. If this condition is satisfied, the processing advances to Step B21, and if not, the processing is terminated.

In Step B21, the gaming terminal 13 provides the coins equivalent to the payout number based on the special game payout data. Thereafter, the gaming terminal 13 terminates the processing.

In Step A26, the horse racing game controller 15 decrements the value in the accumulation coin counter by a sum of the payout numbers, and displays the value in the accumulation coin counter on the accumulated number display 11a.

In Step A27, the horse racing game controller 15 turns off the special game flag and then terminates the processing.

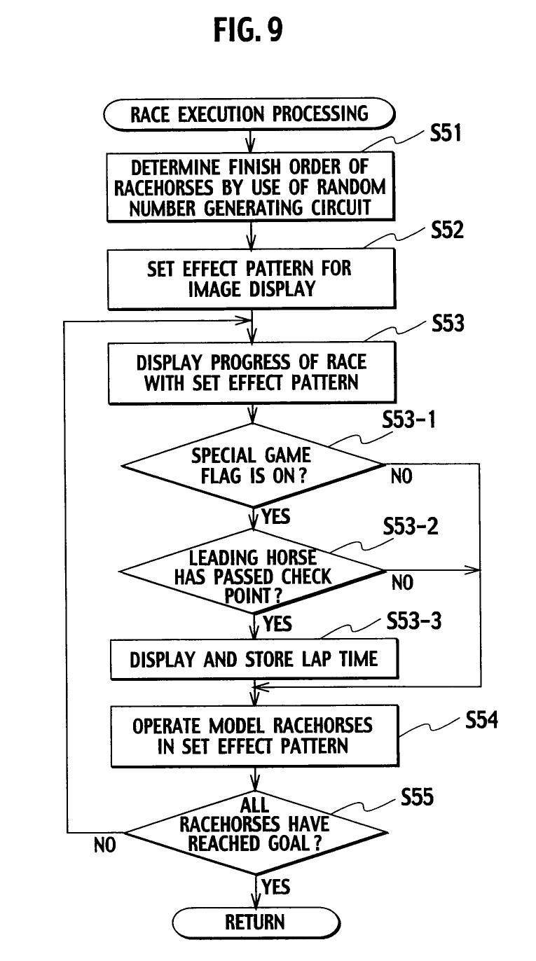

Next, with reference to a flowchart shown in FIG. 9, description will be given of the race execution processing in Step A19 shown in FIG. 8.

In Step S51, the horse racing game controller 15 determines a finish order in the current race based on the random number generated by the random number generating circuit 30. At this point, the finish order in the currently executed race, for example, a rank order from first to eighth is determined.

In Step S52, the horse racing game controller 15 determines contents of a race (for example, running positions of the racehorses at each of points from start to end of the race) based on the finish order of the racehorses, which is determined in Step S51, and sets an effect pattern for image display at each of the points from the start to end of the race based on the contents of the race. Specifically, based on the background image data, the racehorse image data, and the like stored in the image data ROM 26, the image data processor 25 creates effect images of each of the racehorses from start to goal.

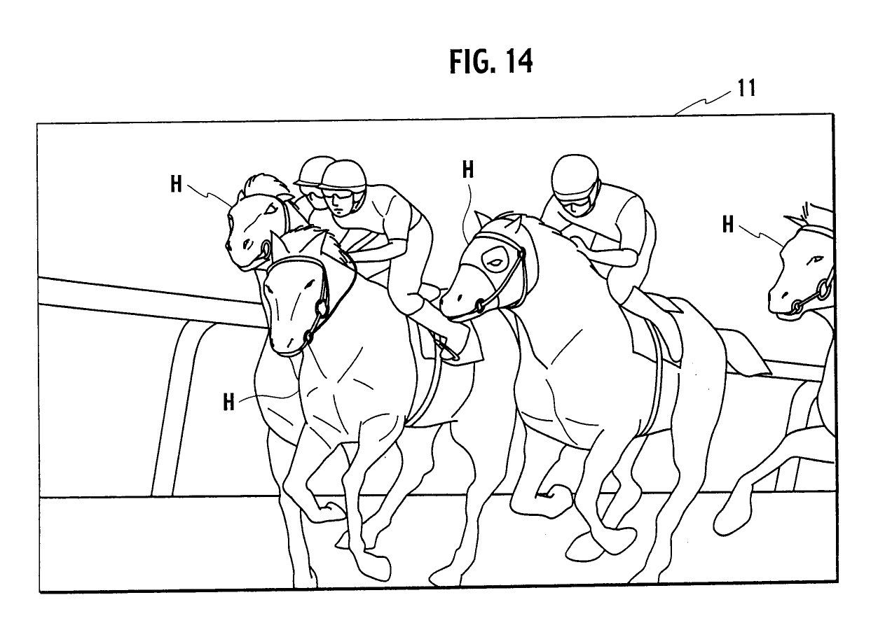

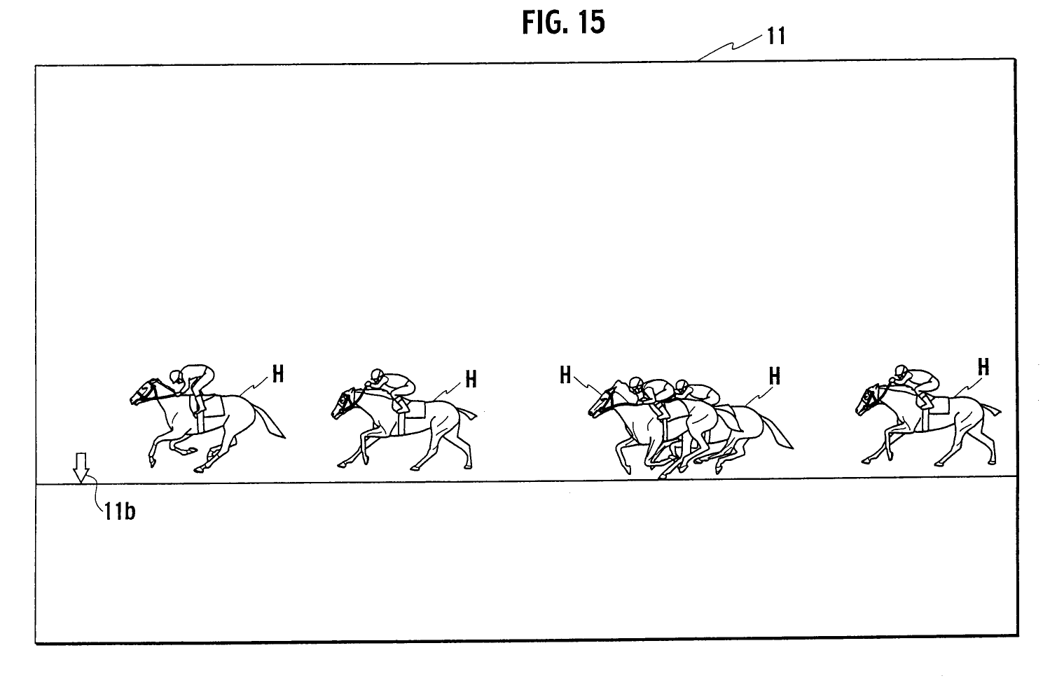

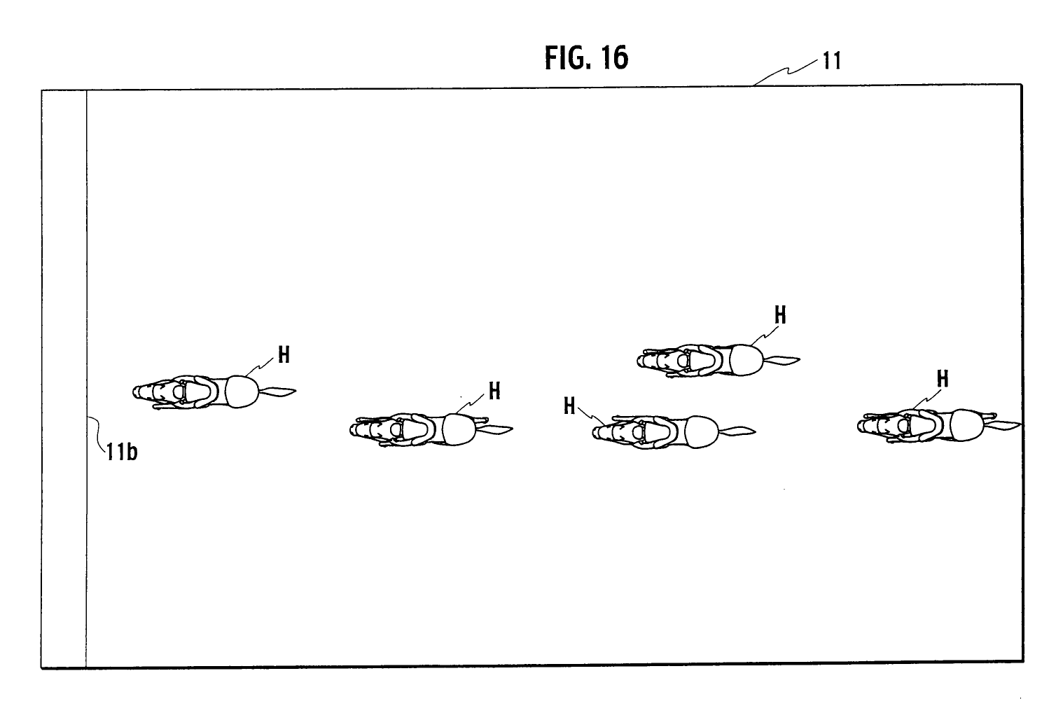

In Step S53, the horse racing game controller 15 displays images indicating a progress of the race on the large-sized display 11 based on the effect images created in Step S52. FIGS. 14 to 16 show display examples. In these display examples, a plurality of racehorses H are displayed from various angles. Furthermore, an image 11b indicating a check point is also displayed. Note that the horse racing game controller 15 starts counting with a timer for measuring a lap time (this timer is formed, for example, in the RAM 23) at the same time as start of the race.

In Step S53-1, the horse racing game controller 15 determines whether or not the special game flag is on. If this condition is satisfied, the processing advances to Step S53-2, and if not, the processing advances to Step S54.

In Step S53-2, the horse racing game controller 15 determines whether or not the leading horse has passed the check point. If this condition is satisfied, the processing advances to Step S53-3, and if not, the processing advances to Step S54.

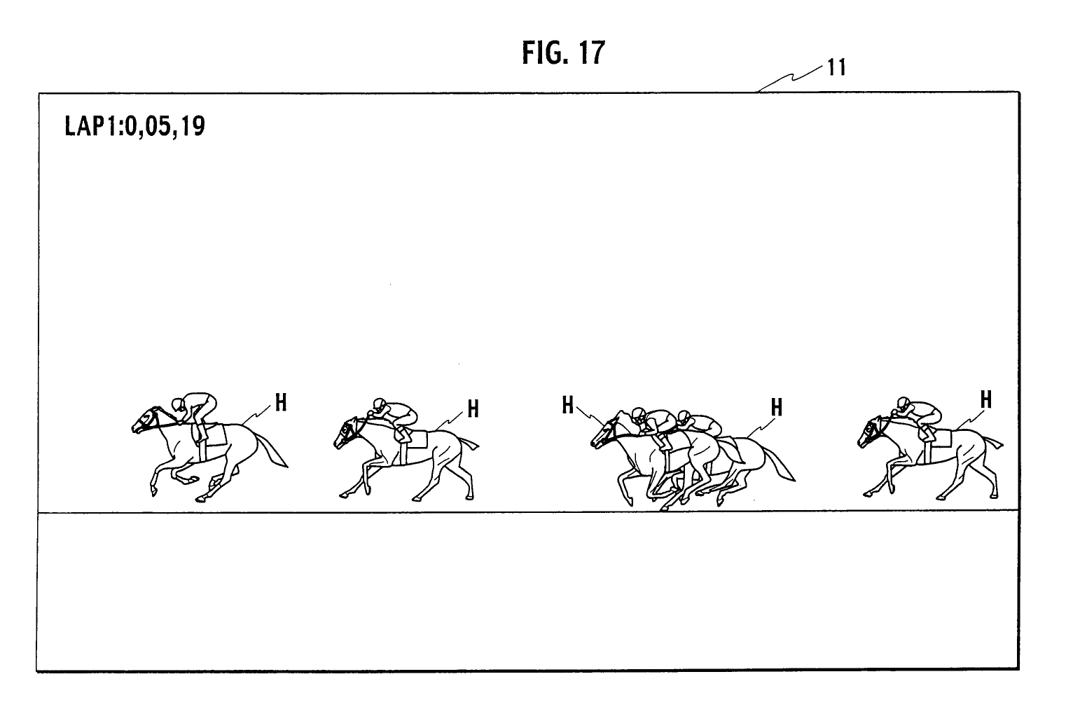

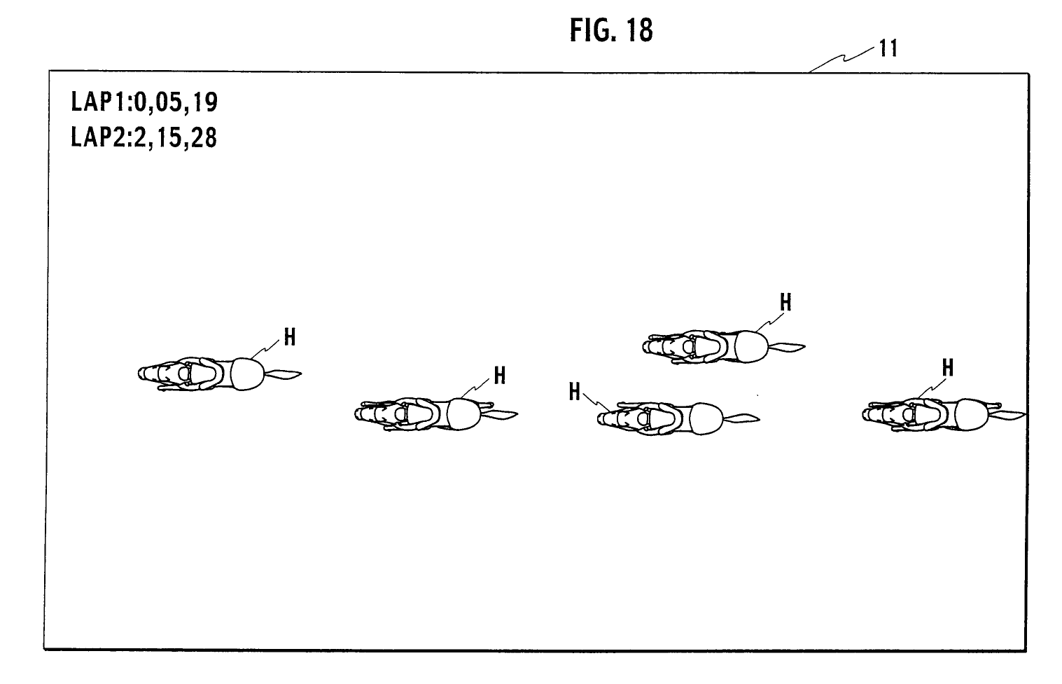

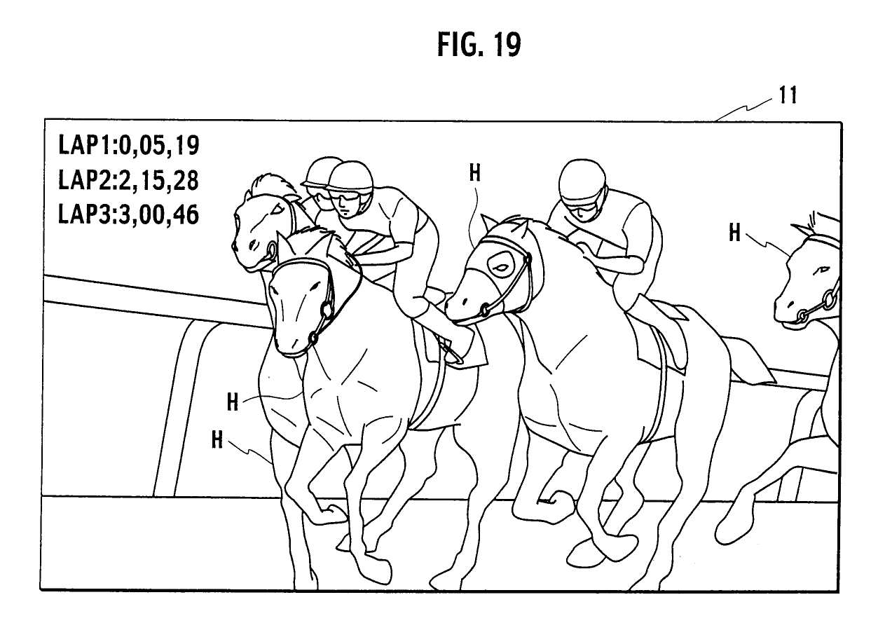

In Step S53-3, the horse racing game controller 15 measures and stores a lap time when the leading horse passed the check point, and displays this lap time on the large-sized display 11. Note that, once the lap time is displayed, the horse racing game controller 15 keeps displaying the lap time until the race is finished. FIGS. 17 to 19 show display examples of the lap time. In FIG. 17, one lap time is displayed. Specifically, at this point, the leading horse has passed only one check point. This means that the race is still in its early stage. In FIG. 18, two lap times are displayed. Specifically, at this point, the leading horse has passed two check points. This means that the race is in its middle stage. In FIG. 19, three lap times are displayed. Specifically, at this point, the leading horse has passed all check points. This means that the race is in its latter stage.

In Step S54, the model controller 29 controls operations of the racehorse models based on the effect images created in Step S52. Thus, behaviors of the respective racehorses displayed on the large-sized display 11 coincide with those of the racehorse models running in the horse race model 12.

In Step S55, the horse racing game controller 15 determines whether or not all the racehorses have reached the goal. When all the racehorses have reached the goal, this processing is terminated.

As described above, the gaming machine 10 measures the lap time when the leading horse passes the check points during execution of the horse racing game. If the lap times set for the gaming terminals 13 match the measured lap times, a predetermined number of coins are provided as a payout from the gaming terminal 13. Therefore, the gaming machine 10 provides an award according to a progress of the horse racing game. Thus, the player can keep up his/her interest in the progress of the horse racing game.

The gaming machine 10 measures the lap times every time the leading horse passes any one of plural check points during execution of the horse racing game. Moreover, the gaming machine 10 determines, for each of the lap times set for the gaming terminal 13, whether or not the matching condition that the lap times set for the gaming terminal 13 match the measured lap times is satisfied. Accordingly, an award corresponding to the number of the lap times satisfying the above condition is provided from the gaming terminal.

Therefore, the gaming machine 10 provides an award according to a progress of the horse racing game. Thus, the player can keep up his/her interest in the progress of the horse racing game. Furthermore, the gaming machine 10 provides the award corresponding to the number of the lap times satisfying the matching condition. Thus, the player can keep up his/her interest also in the number of the lap times satisfying the matching condition. Consequently, the player's interest in the horse racing game can be maintained.

The gaming machine 10 provides the accumulated coins as an award. Thus, resources of awards can be surely secured.

The larger the number of the lap times satisfying the matching condition becomes, the more coins are provided as an award by the gaming machine 10. Thus, it is expected for the player to wish that as many lap times as possible satisfy the matching condition. Consequently, the player's interest in the horse racing game is expected to be maintained.

The gaming machine 10 neither determines whether or not the matching condition is satisfied nor provides an award unless the condition in Step A18-2 is satisfied. Thus, the player can keep up his/her expectations for satisfaction of the condition in Step A18-2. Consequently, the player's interest in the horse racing game can be maintained.

The gaming machine 10 determines whether or not the condition in Step A18-2 is satisfied for each of the gaming terminals 13 and determines whether or not the matching condition is satisfied for the gaming terminal 13 satisfying the condition in Step A18-2. Therefore, the player playing a game at the gaming terminal 13 that does not satisfy the condition in Step A18-2 feels “I want to have fun, too” by watching the player playing the game at the gaming terminal 13 satisfying the condition in Step A18-2 enjoy the progress of the horse racing game. Consequently, the player's interest in the horse racing game is expected to be maintained.

Note that, in the above embodiment, the description was given of the case where the horse race is executed by using both of the large-sized display 11 and the horse race model 12. However, the present invention is not limited thereto but can be applied to the case where the race is displayed on any one of the large-sized display 11 and the horse race model 12. Moreover, the number of the check points is not limited to 3 but may be, for example, 1 or 4.

Although the gaming machine 10 of the present invention has been described above with reference to the illustrated embodiments, the present invention is not limited thereto. The configurations of the components can be replaced by arbitrary configurations having similar functions.

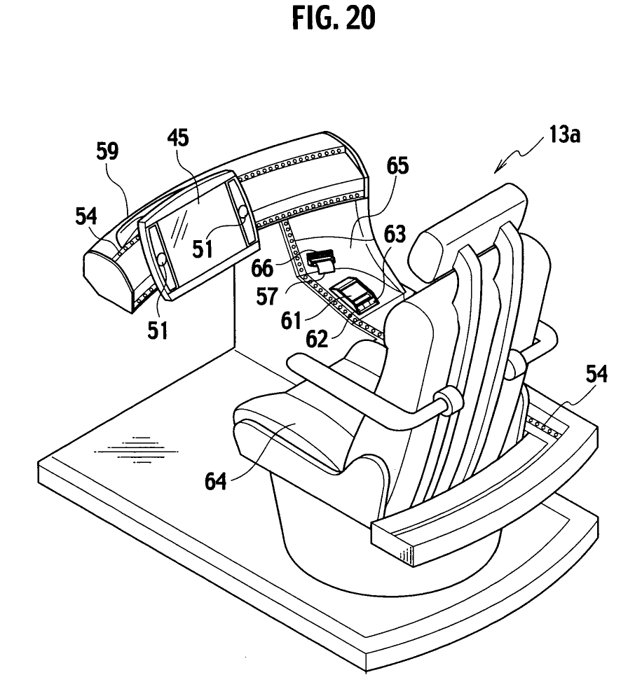

For example, in each of the embodiments described above, the description was given of the example where each of the gaming terminals 13 includes the two displays including the main game display 45 and the sub-game display 48, as shown in FIG. 3. However, the present invention is not limited thereto but can be applied to the case where a gaming terminal 13a includes only a main game display 45 as shown in FIG. 20. In this case, no side game can be executed at each of the gaming terminals 13a.

The gaming machine 10 may perform a payout for the special game in the following manner. Specifically, in the gaming machine 10, first to third accumulated coin counters are prepared. Moreover, every time coins are bet at the gaming terminal 13, a value of the first accumulated coin counter is increased by a% of the number of the coins bet, a value of the second accumulated coin counter is increased by b% thereof, and a value of the third accumulated coin counter is increased by c% thereof. Here, a, b and c are values that satisfy, for example, 10>a>b>c. If one of the lap times out of lap times set for the gaming terminal 13 matches the measured lap time, the gaming machine 10 provides the coins as a payout equivalent to the number indicated by the first accumulated coin counter to the gaming terminal 13. Moreover, if two of the lap times out of lap times set for the gaming terminal 13 match the measured lap times, the gaming machine 10 provides the coins as a payout equivalent to the number indicated by the second accumulated coin counter to the gaming terminal 13. Furthermore, if all of the lap times set for the gaming terminal 13 match the measured lap times, the gaming machine 10 provides the coins as a payout equivalent to the number indicated by the third accumulated coin counter to the gaming terminal 13. Note that, if a payout based on one of the accumulated coin counters can be generated at the plurality of gaming terminals 13, the gaming machine 10 divides the number indicated by the one accumulated coin counter by the number of the gaming terminals 13. Thereafter, the coins equivalent to the number thus obtained are provided as a payout to each of the gaming terminals 13.

The gaming machine 10 may determine whether or not a random number belongs to a predetermined range as a condition for participating in a special game. In this case, the gaming machine 10 acquires a random number for each of the gaming terminals 13 and determines whether or not the random number belongs to the predetermined range.

The gaming machine and controlling method thereof according to the embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiment of the present invention are only a list of optimum effects achieved by the present invention. Hence, the effects of the present invention are not limited to those described in the embodiment of the present invention.

What is claimed is:

1. A gaming machine comprising:
a gaming terminal configured to receive a bet on a horse racing game having simulated racehorses race against each other within a simulated course; and
a controller configured to
(a) set a check point within the simulated course,
(b) set a lap time for the gaming terminal,
(c) execute the horse racing game,
(d) measure a lap time when a leading horse passes the check point during execution of the horse racing game, and
(e) provide an award from the gaming terminal upon the lap time set for the gaming terminal matching the measured lap time.

2. The gaming machine according to claim 1, wherein the controller is configured to
accumulate some of an amount of the bet received at the gaming terminal, and
provide the accumulated bet amount as an award from the gaming terminal upon the lap time set for the gaming terminal matching the measured lap time.

3. A gaming machine comprising:
a gaming terminal configured to receive a bet on a horse racing game having simulated racehorses race against each other within a simulated course; and
a controller configured to
(a) set a plurality of check points within the simulated course,
(b) set a plurality of lap times for the gaming terminal,
(c) execute the horse racing game,
(d) measure a lap time every time a leading horse passes any of the plurality of check points during execution of the horse racing game,
(e) determine, for each of the lap times set for the gaming terminal, whether or not a matching condition that the lap time set for the gaming terminal matches the measured lap time is satisfied, and
(f) provide from the gaming terminal an award corresponding to a number of the lap times satisfying the matching condition.

4. The gaming machine according to claim 3, wherein the controller is configured to
accumulate some of an amount of the bet received at the gaming terminal, and
provide an amount corresponding to the number of the lap times satisfying the matching condition among the accumulated bet amount as an award from the gaming terminal.

5. The gaming machine according to claim 4, wherein the controller is configured to provide the more bet amount as the award, as the larger number of the lap times satisfies the matching condition.

6. A gaming machine comprising:
a gaming terminal configured to receive a bet on a horse racing game having simulated racehorses race against each other within a simulated course; and
a controller configured to
(a) set a check point within the simulated course,
(b) set a lap time for the gaming terminal,
(c) execute the horse racing game,
(d) measure a lap time when a leading horse passes the check point during execution of the horse racing game,
(e) determine whether or not a predetermined condition set for the gaming terminal is satisfied,
(f) upon satisfaction of the predetermined condition, determine whether or not a matching condition that the lap time set for the gaming terminal matches the measured lap time is satisfied, and
(g) provide an award from the gaming terminal upon satisfaction of the matching condition.

7. A gaming machine comprising:
a plurality of gaming terminals configured to receive bets on a horse racing game having simulated racehorses race against each other within a simulated course; and
a controller configured to
(a) set a check point within the simulated course,
(b) set a lap time for each of the gaming terminals,
(c) execute the horse racing game,
(d) measure a lap time when a leading horse passes the check point during execution of the horse racing game,
(e) determine whether or not a predetermined condition set for each of the gaming terminals is satisfied,
(f) determine, for the gaming terminal satisfying the predetermined condition, whether or not a matching condition that the lap time set for the gaming terminal matches the measured lap time is satisfied, and
(g) provide an award from the gaming terminal satisfying the matching condition.

8. A method for controlling a gaming machine, comprising:
receiving, at a gaming terminal, a bet on a horse racing game having simulated racehorses race against each other within a simulated course;
setting a check point within the simulated course;
setting a lap time for the gaming terminal;
executing the horse racing game;
measuring a lap time when a leading horse passes the check point during execution of the horse racing game; and
providing an award from the gaming terminal upon the lap time set for the gaming terminal matching the measured lap time.

9. The method for controlling a gaming machine, according to claim 8, further comprising:
accumulating some of an amount of the bet received at the gaming terminal,
wherein the accumulated bet amount is provided as an award from the gaming terminal upon the lap time set for the gaming terminal matching the measured lap time.
